(19) United States
(12) Patent Application Publication
(10) Pub. No.: US 2010/0166241 A1
(43) Pub. Date: Jul. 1, 2010

(54) Hearing aid ear dome

(76) Inventor: Guillermo L. Sabio, Orlando, FL (US)

Correspondence Address: William M. Hobby, III, Suite 375, 157 E. New England Avenue, Winter Park, FL, 32789, US

(21) Appl. No.: 12/317,667

(22) Filed: Dec. 29, 2008

(51) Int. Cl. H04R 25/00

(52) U.S. Cl. 381/328

(57) ABSTRACT

The present invention relates to an ear tip for the end of the tube coupling the hearing aid receiver to the ear canal of a receiver wearing the hearing aid. The ear tip has variable openings therethrough for adjusting and reducing the occlusion effect in the ear canal. The ear tip may be connected to a sound tube from a receiver mounted in the hearing aid or may have the receiver mounted directly within the ear tip for insertion in the ear canal.

### BACKGROUND OF THE INVENTION

### 1. Field of the Invention

The present invention relates to a hearing aid system, and especially to an ear tip for a hearing aid to fit into an ear canal.

A typical hearing aid system includes a hearing aid case, a tube having a preformed shape connected to the hearing aid case, and an ear tip on the end of the tube. The hearing aid case may be configured to be worn behind the ear of a user and contains a microphone, a processor unit, and a speaker for delivering amplified sounds to the output of the case. A tube has one end attached to the output of the case and has an ear tip attached to the other end. The ear tip may be configured to fit within the ear canal while allowing sounds outside and within the ear to pass-through the ear canal around the ear tip.

Hearing aids have been developed to correct the hearing of users having various degrees of hearing impairments. Generally, hearing loss is not uniform over the entire audio frequency range. For example, hearing loss for sounds at higher audio frequencies, such as above 1,000 Hz, will be more pronounced for some people while hearing loss for sounds at lower frequencies will be more pronounced for other people.

Most people having hearing impairments have mild hearing losses with normal or nearly normal hearing in the low frequency ranges and hearing losses in the higher frequency ranges, especially mild hearing losses at high frequencies with low amplitudes.

The traditional approach for correcting hearing impairments has been to employ either an electronic “in the ear” (ITE) hearing aid device inserted into the ear of the user or a “behind the ear” (BTE) hearing aid device attached behind the ear. The ITE hearing aid devices are custom made to fit within the ear and ear canal of the particular user. The BTE hearing aid devices include a flexible plastic tube connecting a behind the ear device to an ear mold placed within the ear. Both the ITE and BTE hearing aid devices tend to block the ear canal so that little or no sound can reach the ear in a natural, unaided manner.

Hearing aid systems which block the ear canal almost entirely cause a problem known as the occlusion effect. The occlusion effect is caused by the increased transmission of sound by bone conduction when the ear canal is blocked and ear conduction is impeded. This occlusion effect results in sounds which are unnatural and uncomfortable for the user. In particular, the user's voice sounds unnaturally higher than normal.

Some hearing aid systems have been made employing vents in the ear mold which reduce the occlusion effect partially. These vents allow the user to hear some natural sounds through a device positioned in the ear. Although vents provide some improvement in decreasing the occlusion effect, distortion of the user's voice remains a problem.

In an effort to alleviate some of the aforementioned problems, some BTE hearing aids have been designed with a flexible tube that extends into the ear canal and is held in place within the ear canal by an ear mold that leaves the ear canal generally unobstructed. Although the relatively open ear canal of these devices overcomes some of the occlusion effect, these hearing aids suffer from a number of other problems. For instance, the BTE hearing aids employ a rigid plastic ear hook to secure the BTE device on the ear. The ear hook connects a hearing aid casing positioned behind the ear to a flexible plastic tubing which extends into the ear. A flexible tube can be used which can be cut to an appropriate length for a particular user. The ear mold which secures the end of the flexible hearing aid tube within the ear canal has to be custom manufactured to fit the user's ear to sufficiently secure the hearing aid tube in place in the ear canal and prevent the ear mold from falling out of the ear. The custom made ear mold adds to the cost of the device and the time needed to fit the hearing aid.

There are some stock ear canal ear tips available. Some of the stock ear canal ear tips are formed of hard materials, some are formed of solid rubber, and some are formed of foam. In general, stock ear canal ear tips have problems with holding the end of the flexible hearing aid tube securely in place. When these stock ear canal ear tips fit tight enough to hold the tube in the ear, they are usually uncomfortable.

It has also been suggested to put the hearing aid receiver into the ear for improving the sound in the ear. In U.S. Pat. No. 7,421,086 to Bauman et al., a hearing aid system has the receiver unit configured and positioned within the user's ear canal to minimize insertion loss and the occlusion effect.

One prior art ear canal ear tip can be seen in the Fretz et al. U.S. Pat. No. 7,027,608 for a Behind the Ear Hearing Aid System or an open ear canal hearing aid ear tip. Another hearing aid attachment for the ear canal may be seen in the Caldarola U.S. Patent Application Publication No. US 2008/0123889 for an Open Fit Canal Hearing Device and in the Saltykov U.S. Pat. No. 6,860,362 for a Hearing Aid Instrument Flexible Attachment and in the Brown et al. U.S. Pat. No. 6,129,174 for a Minimal Contact Replaceable Acoustic Coupler.

The present hearing aid ear tip has an adjustable dome which reduces the occlusion effect and can be used without an expensive custom made ear mold, and provides a comfortably fitting device.

### SUMMARY OF THE INVENTION

An ear tip apparatus for a hearing-aid system is provided for attaching to a hearing aid sound output for insertion into a person's ear. A hearing aid has a microphone for picking up sound connected to an amplifier for the amplification of the signals from the microphone and an output receiver for producing the amplified sound in a person's ear canal. A typical behind-the-ear hearing aid has the receiver attached to a tube which extends from the receiver to inside the ear canal for transferring the sound into the ear canal. The tube typically has an ear tip on the end thereof for attaching in the ear. The receiver may be separated from the amplifier and placed directly in the ear canal for producing the sound output from the amplifier.

The present ear tip has an inner dome having a plurality of spaced openings around a center axis and an outer dome having an output bore along the center axis and having a plurality of openings spaced therearound. The outer dome is rotatably mounted over the inner dome and positioned to rotate the outer dome so that rotating one dome relative to the other rotates the plurality of spaced openings in each dome relative to the other dome for varying the passageways through the inner and outer dome openings. The ear tip outer dome sound output bore is coupled to the hearing aid receiver. The outer dome has a hollow sleeve attached thereto and extending through the inner dome to the hearing aid sound output. The hollow sleeve is coupled to the hearing aid sound transmission tube which is coupled to the hearing aid receiver. The hearing aid receiver may be mounted in the hollow sleeve or may be mounted in the hearing aid casing with the hollow tube extending therefrom. The outer and inner domes may have three or four or any plurality of openings spaced so that when the outer and inner domes are rotated relative to each other, they will block or open varying degrees of passageways therethrough. The passageways are adjusted prior to inserting the dome into the ear to reduce the occlusion effect in the ear canal.

### BRIEF DESCRIPTION OF THE DRAWINGS

Other objects, features, and advantages of the present invention will be apparent from the written description and the drawings in which:

FIG. 1 is a perspective view of the hearing aid ear tip in accordance with the present invention attached to a sound tube;

FIG. 2 is a perspective view of the ear tip of FIG. 1 having the openings therethrough reduced in size;

FIG. 3 is a perspective view of an ear tip of FIGS. 1 and 2; and

FIG. 4 is an exploded view of an ear tip in accordance with the present invention having an external hearing aid receiver mounted in the ear tip.

### DESCRIPTION OF THE PREFERRED EMBODIMENTS

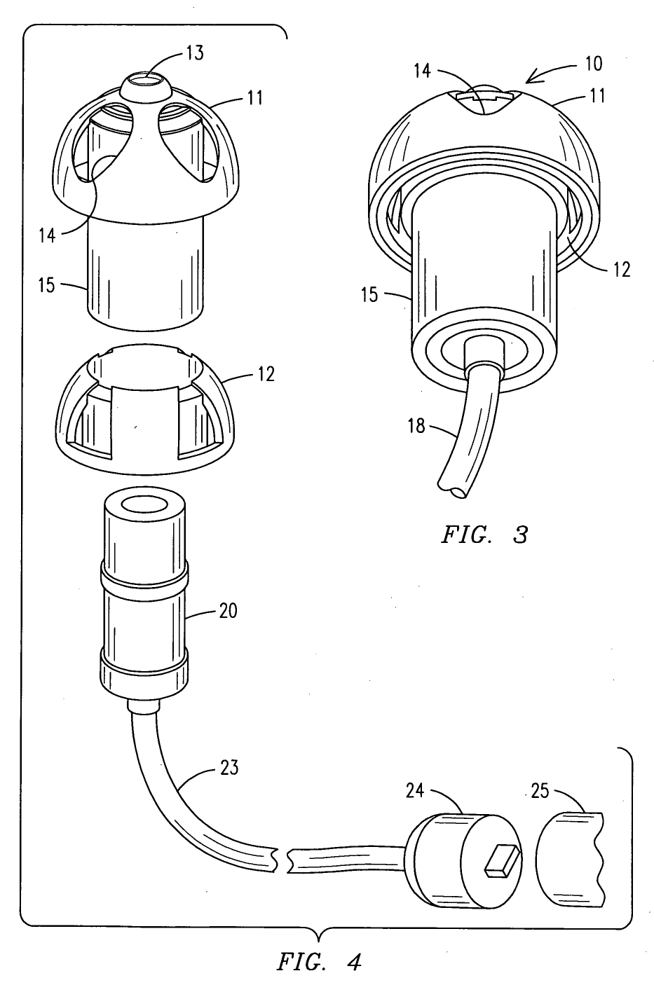

Referring to FIGS. 1 through 4 of the drawings, an ear tip 10 is formed of an outer dome 11 and inner dome 12. Outer dome 11 has a sound output bore 13 coming out of the center thereof and which bore may be covered with a filter screen 19 to protect against ear wax getting into the bore and into the receiver. Outer dome 11 has a plurality of openings 14 spaced therearound the center bore 13. The outer dome 11 is rotatably mounted to the inner dome 13 and has a sleeve 15 extending therefrom having the bore 13 extending therethrough. The inner dome may have an equal number of openings 16 spaced therearound and has an open center area 17 shaped to fit over the sleeve 15 to bring the domes 11 and 12 together, as shown in FIGS. 1 through 3. A sound tube 18 is connected from a hearing aid receiver in the hearing aid or the receiver 20 may be mounted directly into the sleeve 15. The domes 11 and 12 rotate relative to each other so that the openings 14 in the outer dome 11 and the openings 16 in the inner dome 12 can be rotated relative to each other to open or close the passageway through the domes 11 and 12.

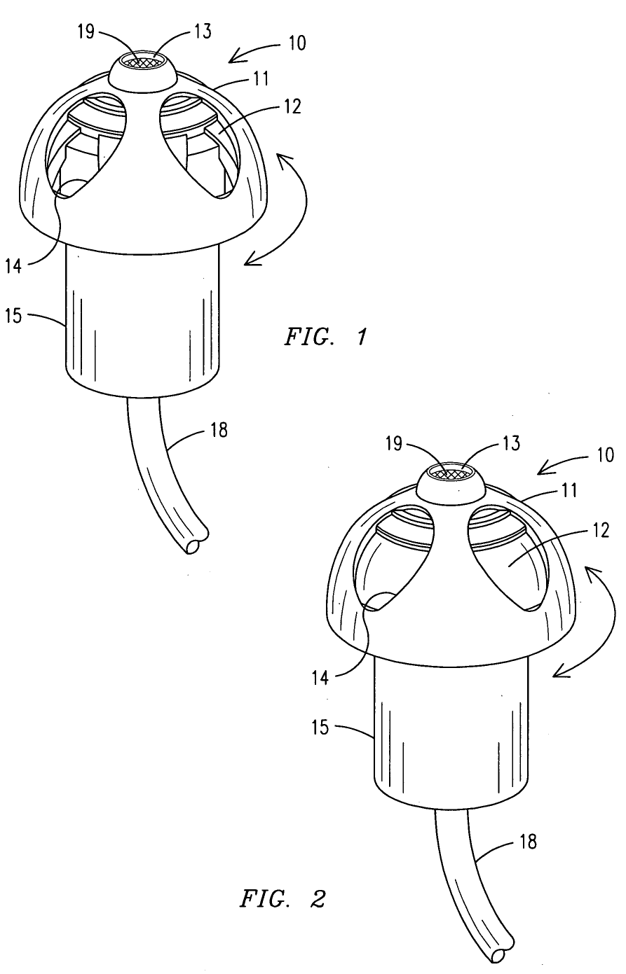

FIG. 1 shows the domes 11 and 12 rotated to align the openings with each other to allow for a greater passageway than that shown in FIG. 2 where the outer dome 11 has been rotated to substantially close the openings 14. The solid spaces 21 have been rotated to cover the openings of the outer dome.

The inner dome 12 is press fitted onto the outer dome 11 sleeve 15 so that the domes can be rotated relative to each other to adjust the amount of sound that can pass therethrough from inside the ear canal to reduce the occlusion effect of the ear tip mounted in the ear canal.

FIG. 4 shows the receiver 20 being mounted in the sleeve 15 of the outer dome, the receiver 20 can have the sound output tube 22 which couples to the sound output bore 13 of the outer dome. The receiver 20 is externally mounted separate from the amplifier of the hearing aid and is connected with electrical wires through the tube 23 having an electrical connector 24 attached thereto which is in turn attached to the hearing aid 25 to receive the output signals from the amplifier of the hearing aid.

The present invention, by allowing the openings through the ear tip dome to be varied, allows for the custom adjustment of the openings therethrough to thereby adjust and reduce the occlusion effect and amount of low frequency amplification of the ear tip when mounted in a person's ear canal. This allows for a custom adjustment for each particular individual prior to attaching the hearing aid to the person's ear. It can also be readjusted later by removing the hearing aid tip and readjusting the opening for a particular person. Tests have shown that the present ear tip dome provides 10 dB of more low frequency amplification at 125, 250, 500 and 750 and 1000 Hz in the completely open configuration as compared to the normal basket open fit products presently used. Tests have shown that the dome provides as much as 40 dB of more low frequency amplification at 250 Hz, 38 dB of more amplification at 500 Hz, 12 dB of more amplification at 750 Hz and 10 dB or more amplification at 1000 Hz in the completely closed configuration as compared with the normal basket open fit product.

It should be clear at this point that a customizable ear tip can be readily adjusted for any particular patient's ear and hearing loss by the simple expedient of rotating a pair of ear tip domes relative to each other to open or close the passageways therethrough. However, the present invention should not be construed as limited to the forms shown which are to be considered illustrative rather than restrictive.

I claim:

1. An ear tip for a hearing aid sound output for insertion into a person's ear comprising:
an ear tip inner dome having a plurality of spaced openings therearound;
an ear tip outer dome having a hearing aid sound output bore and having a plurality of spaced openings spaced therearound, said outer dome being rotatably mounted over said inner dome and positioned to rotate the outer dome plurality of spaced openings relative to said inner dome plurality of spaced openings for varying the overlapping of the plurality of inner and outer domes and the openings therethrough; and
means for coupling said ear tip outer dome sound output bore to a hearing aid;
whereby a hearing aid ear tip has adjustable openings therethrough.

2. The ear tip for a hearing aid in accordance with claim 1 in which said means for coupling said ear tip outer dome sound output bore includes a hollow sleeve attached to said outer dome and extending through said inner dome to the hearing aid sound output.

3. The ear tip for a hearing aid in accordance with claim 2 in which said hollow sleeve is coupled to a hearing aid sound transmission tube.

4. The ear tip for a hearing aid in accordance with claim 2 in which said hollow sleeve is coupled to a hearing aid receiver.

5. The ear tip for a hearing aid in accordance with claim 2 in which said outer dome is rotatably attached to said inner dome.

6. The ear tip for a hearing aid in accordance with claim 2 in which said hearing aid receiver is mounted in said hollow sleeve and has a sound transmission tube extending therefrom.

7. The ear tip for a hearing aid in accordance with claim 2 in which said outer dome has four spaced openings around said sound output bore.

8. The ear tip for a hearing aid in accordance with claim 2 in which said inner dome has a center opening having said hollow sleeve passing therethrough.

9. The ear tip for a hearing aid in accordance with claim 8 in which said inner dome has four spaced openings around said center opening.
